(19) United States
(12) Patent Application Publication
(10) Pub. No.: US 2026/0195283 A1
(43) Pub. Date: Jul. 9, 2026

(54) ELECTRONIC DEVICE HAVING EXTENSION PORT AND UTILIZATION METHOD OF EXTENSION PORT

(71) Applicant: WINMATE INC., New Taipei City (TW)

(72) Inventors: KU-CHING LU, New Taipei City (TW); CHIH-HSIANG WANG, New Taipei City (TW); WEN-JU TSAI, New Taipei City (TW); HAO-YUAN HSUEH, New Taipei City (TW)

(21) Appl. No.: 19/012,224

(22) Filed: Jan. 7, 2025

(51) Int. Cl. G06F 13/40

(52) U.S. Cl. CPC G06F 13/4045; G06F 2213/40

(57) ABSTRACT

An electronic device has a port extension module and an original type-C USB port mounted on a shell. The port extension module includes a processing unit, a signal isolation circuit, and a hub. When the signal isolation circuit receives a first voltage signal from the processing unit, and when the hub receives a third voltage signal from the processing unit, the electronic device retains original functions for the original type-C USB port. When the signal isolation circuit receives a second voltage signal from the processing unit, and when the hub receives a fourth voltage signal from the processing unit, the signal isolation circuit isolates CC1 and CC2 pins of the original type-C USB port and outputs a host mode signal to the processing unit, and the hub is able to return a signal outputted from a type-C USB port or a pogo pin female connector to the processing unit.

### BACKGROUND OF THE INVENTION

### 1. Field of the Invention

The present invention relates to an electronic device having an extension port and utilization method of an extension port that enables the electronic device to extend a number of ports.

### 2. Description of the Related Art

Currently, most smart electronic devices on the market only have one single port. For example, a plurality of smart phones and tablet computers only respectively have a single universal serial bus (USB) port for charging and file transfers. In order to improve user experience, in theory, more ports should be added to the smart electronic device for better convenience and better flexibility in using the smart electronic device. For example, in order to add a plurality of extension ports to a smart phone that has only a single port for satisfying a need of using a plurality of different external devices with the smart phone, such as, for satisfying a need of using a card reader, a finger print scanner, and a high quality microphone on the smart phone, a current goal is to improve technical means to extend new USB ports to a smart phone that has only a single port.

However, adding extension USB ports to the smart phone is technically quite difficult. When a processing unit of a smart phone detects a status of a USB port, the processing unit would use a signal from the USB port to confirm what a relation is between the USB port of the smart phone and an external device. For example, the smart phone would first use the signal obtained from the USB port to determine whether itself (the smart phone) is in host mode (master mode) or in device mode (slave mode), and only once determined, the smart phone would subsequently proceed to function in tandem with the external device that is connected to the USB port of the smart phone. For instance, when the smart phone is electrically connected to a computer, usually the computer would be in host mode and the smart phone would be in device mode. When the smart phone is electrically connected to a high quality microphone, the smart phone would be in host mode and the high quality microphone would be in device mode.

A current problem is the following: when the smart phone intents to add extension USB ports, the processing unit of the smart phone must be in host mode to electrically connect to a hub, thus allowing the smart phone to control the hub. However, while in host mode, the processing unit of the smart phone does not allow information to send back from the extension USB ports to the processing unit via the hub. This limitation of inability to return information from the extension USB ports to the processing unit via the hub is due to a limitation of how signals are designed to flow in current circuits. Without returning information from the extension USB ports to the processing unit via the hub, the extension USB ports can hardly be considered fully usable.

Therefore, overall, to add extension ports to a smart electronic device that has only a single port is a technically difficult task, and a current goal is to improve technical means to extend new ports to the smart device.

### SUMMARY OF THE INVENTION

To effectively extend usable ports on an electronic device, the present invention provides an electronic device having an extension port and a utilization method of an extension port.

The electronic device having an extension port of the present invention includes:
a shell;
an original type-C universal serial bus (USB) port, mounted on the shell, and having a positive data (D+) pin, a negative data (D−) pin, a first configuration channel (CC1) pin, and a second configuration channel (CC2) pin;
a port extension module, having:
   a processing unit, having a general-purpose input/output (GPIO), wherein the GPIO includes a first enable pin, a second enable pin, a first switch control pin, a second switch control pin, a pair of USB mode detection pins, and a pair of first signal pins;
   a signal isolation circuit, electrically connected to the first enable pin, the second enable pin, and the pair of USB mode detection pins of the processing unit, and also electrically connected to the CC1 pin and the CC2 pin of the original type-C USB port;
   a hub, having a plurality of type-C USB ports and at least one pogo pin female connector, and electrically connected to the first switch control pin, the second switch control pin, and the first signal pins of the processing unit; wherein the type-C USB ports and at least one pogo pin female connector are mounted on the shell;
   wherein when the signal isolation circuit respectively receives a first voltage signal from the first enable pin and from the second enable pin of the processing unit, and when the hub respectively receives a third voltage signal from the first switch control pin and from the second switch control pin of the processing unit, the signal isolation circuit controls the CC1 pin and the CC2 pin of the original type-C USB port to electrically connect the pair of USB mode detection pins of the processing unit according to the first voltage signal, and the hub controls the D+ pin and the D− pin of the original type-C USB port to electrically connect the pair of first signal pins of the processing unit according to the third voltage signal;
   wherein when the signal isolation circuit respectively receives a second voltage signal from the first enable pin and from the second enable pin of the processing unit, and when the hub respectively receives a fourth voltage signal from the first switch control pin and from the second switch control pin of the processing unit, the signal isolation circuit controls the CC1 pin and the CC2 pin of the original type-C USB port to become open circuit according to the second voltage signal, the signal isolation circuit also generates a host mode signal and outputs the host mode signal to the pair of USB mode detection pins of the processing unit, and the hub controls one of the type-C USB ports or the pogo pin female connector to electrically connect the pair of first signal pins of the processing unit and the D+ pin and the D− pin of the original type-C USB port according to the fourth voltage signal.

The utilization method of extension port of the present invention is executed by the processing unit of the aforementioned electronic device. The utilization method includes the following steps:
respectively outputting an isolation voltage signal from a first enable pin and from a second enable pin of the processing unit to a signal isolation circuit, and receiving a USB mode signal from a pair of USB mode detection pins of the processing unit; wherein when the isolation voltage signal is a second voltage signal, the USB mode signal is a host mode signal;
respectively outputting a transfer voltage signal from a first switch control pin and from a second switch control pin of the processing unit to a hub; wherein when the transfer voltage signal is a fourth voltage signal, the processing unit receives a communication information outputted from a type-C USB port on the hub or from a pogo pin female connector on the hub.

As such, a circuit structure disclosed by the present invention allows for the original type-C USB port to retain its original function, while also allows for having a function of switchable usage between extension ports. More particularly, when the signal isolation circuit receives the first voltage signal from the processing unit, and when the hub receives the third voltage signal from the processing unit, the processing unit is able to retain the original function of the original type-C USB port. When the signal isolation circuit receives the second voltage signal from the processing unit, and when the hub receives the fourth voltage signal from the processing unit, the processing unit is able to enable usage of an extension port, such as enabling the type-C USB port on the hub or the pogo pin female connector on the hub for use.

More particularly, when enabling an extension port for use, the signal isolation circuit of the port extension module is able to adjust its electrical connections according to the second voltage signal, and thus isolating (preventing) the pair of USB mode detection pins of the processing unit from receiving signals coming from the CC1 pin and the CC2 pin of the original type-C USB port. Simultaneously, the signal isolation circuit outputs the host mode signal to the processing unit for allowing the processing unit to stay in host (master) mode, and as a result, the processing unit is able to control the hub while being in host mode. On the other hand, the hub is able to adjust its electrical connections according to the fourth voltage signal, thus, allowing one of the type-C USB ports or the pogo pin female connector of the hub to electrically connect to the pair of first signal pins of the processing unit, and allowing the D+ pin and the D− pin of the original type-C USB to electrically connect to the pair of first signal pins of the processing unit through the hub. As a result, the present invention is able to send the communication information from one of the type-C USB ports, the pogo pin female connector, or the original type-C USB port back to the processing unit, and thus overcoming the limitations for extension ports mentioned in prior art. In other words, the present invention is able to solve the following problems:
(1). having insufficient numbers of type-C USB ports (or of any type of USB ports) available for use on an electronic device; and
(2). having the processing unit unable to stay in host mode for controlling the hub, and thus having the processing unit unable to receive the communication information returning from the hub for the extension ports that are on the hub.

### BRIEF DESCRIPTION OF THE DRAWINGS

FIG. 1 is a block diagram of an electronic device having extension port of the present invention.

FIG. 2 is a circuit diagram of a signal isolation circuit of the electronic device of the present invention.

FIG. 3 is a circuit diagram of a hub of the electronic device of the present invention.

FIG. 4 is an external perspective view of the electronic device of the present invention.

FIG. 5 is a flow chart of a utilization method of extension port of the present invention.

FIG. 6 is another flow chart of the utilization method of the present invention.

### DETAILED DESCRIPTION OF THE INVENTION

The present invention provides an electronic device having extension port and utilization method of extension port.

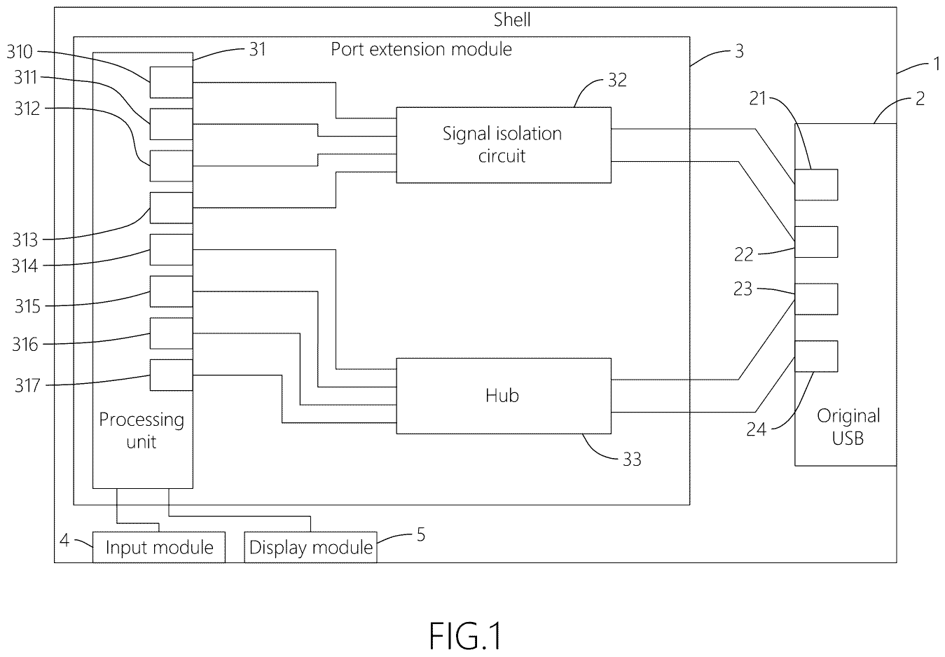

With reference to FIG. 1, an electronic device having extension port of the present invention includes a shell 1, an original type-C universal serial bus (USB) port 2, and a port extension module 3.

The original type-C USB port 2 is a USB connector that the electronic device originally has. In other words, the original type-C USB port 2 is not an extension port subsequently added to the electronic device, but a USB connector originally configured for the electronic device. The original type-C USB port 2 is mounted on the shell 1, and the original type-C USB port 2 includes a first configuration channel (CC1) pin 21, a second configuration channel (CC2) pin 22, a positive data (D+) pin 23, and a negative data (D−) pin 24.

The port extension module 3 includes a processing unit 31, a signal isolation circuit 32, and a hub 33.

The processing unit 31 includes a general-purpose input/output (GPIO), and the GPIO further includes a first enable pin 310, a second enable pin 311, a pair of USB mode detection pins 312, 313, a first switch control pin 314, a second switch control pin 315, and a pair of first signal pins 316, 317. The pair of USB mode detection pins 312, 313 includes a first USB mode detection pin 312 and a second USB mode detection pin 313. The pair of first signal pins 316, 317 includes a first signal positive pin 316 and a first signal negative pin 317. In an embodiment of the present invention, the first enable pin 310 is EN1 pin of the GPIO, the second enable pin 311 is EN2 pin of the GPIO, the first switch control pin 314 is SW1 pin of the GPIO, and the second switch control pin 315 is SW2 pin of the GPIO.

The signal isolation circuit 32 is electrically connected to the first enable pin 310, the second enable pin 311, and the pair of USB mode detection pins 312, 313 of the processing unit 31, and the signal isolation circuit 32 is also electrically connected to the CC1 pin 21 and the CC2 pin 22 of the original type-C USB port 2.

The hub 33 includes a plurality of type-C USB ports and at least one pogo pin female connector, and the plurality of type-C USB ports and the at least one pogo pin female connector are mounted on the shell 1. The hub 33 is electrically connected to the first switch control pin 314, the second switch control pin 315, and the pair of first signal pins 316, 317 of the processing unit 31. Please note that the aforementioned plurality of type-C USB ports can hereby also be replaced by a plurality of other types of USB ports, such as a combination of type-A USB, type-B USB, mini-USB type-B, or micro USB type-B connectors. Moreover, the aforementioned pogo pin female connector that is mounted on the shell 1, refers to a place where electrodes of a plurality of pogo pins on a docking station are configured for electrical connections. The docking station may be detachably connected to the electronic device. The place, where electrodes of the pogo pins on the docking station are configured for electrical connections, is hereby defined as the pogo pin female connector in the present invention, and it is believed that a person skilled in the art should be able to accept this definition with ease.

When the signal isolation circuit 32 respectively receives a first voltage signal from the first enable pin 310 and from the second enable pin 311 of the processing unit 31, and when the hub 33 respectively receives a third voltage signal from the first switch control pin 314 and from the second switch control pin 315 of the processing unit 31, the signal isolation circuit 32 controls the CC1 pin 21 and the CC2 pin 22 of the original type-C USB port 2 to electrically connect the pair of USB mode detection pins 312, 313 of the processing unit 31 according to the first voltage signal, and the hub 33 controls the D+ pin 23 and the D− pin 24 of the original type-C USB port 2 to electrically connect the pair of first signal pins 316, 317 of the processing unit 31 according to the third voltage signal.

As a result, the electronic device of the present invention is able to retain original function of the original type-C USB port 2. The reason behind such an outcome, is because the CC1 pin 21 and the CC2 pin 22 of the original type-C USB port 2 are able to send signals outputted by an external device to the pair of USB mode detection pins 312, 313 of the processing unit 31, for notifying the processing unit 31 whether to be in a host (master) mode or to be in device (slave) mode when connecting to the external device. In this case, the external device is electrically connected to the original type-C USB port 2. Furthermore, as the D+ pin 23 and the D− pin 24 of the original type-C USB port 2 are electrically connected to the pair of first signal pins 316, 317 of the processing unit 31, the original type-C USB port 2 retains its function for sending information from the external device via the original type-C USB port 2 to the processing unit 31.

On the other hand, when the signal isolation circuit 32 respectively receives a second voltage signal from the first enable pin 310 and from the second enable pin 311 of the processing unit 31, and when the hub 33 respectively receives a fourth voltage signal from the first switch control pin 314 and from the second switch control pin 315 of the processing unit 31, the signal isolation circuit 32 controls the CC1 pin 21 and the CC2 pin 22 of the original type-C USB port 2 to become open circuit according to the second voltage signal, the signal isolation circuit 32 also generates a host mode signal and outputs the host mode signal to the pair of USB mode detection pins 312, 313 of the processing unit 31, and the hub 33 controls one of the type-C USB ports or the pogo pin female connector to electrically connect the pair of first signal pins 316, 317 of the processing unit 31 and the D+ pin 23 and the D− pin 24 of the original type-C USB port 2 according to the fourth voltage signal.

As a result, the electronic device of the present invention allows for having a function of switchable usage between extension ports. In other words, when the signal isolation circuit 32 receives the second voltage signal from the processing unit 31, and when the hub 33 receives the fourth voltage signal from the processing unit 31, the processing unit 31 enables an extension port for use. When enabling an extension port for use, the signal isolation circuit 32 of the port extension module 3 is able to adjust its electrical connections according to the second voltage signal, and thus isolating (preventing) the pair of USB mode detection pins 312, 313 of the processing unit 31 from receiving signals coming from the CC1 pin 21 and the CC2 pin 22 of the original type-C USB port 2. Simultaneously, the signal isolation circuit 32 outputs the host mode signal to the processing unit 31 for keeping the processing unit 31 to stay in host (master) mode. On the other hand, the hub 33 is able to adjust its electrical connections according to the fourth voltage signal, thus, allowing one of the type-C USB ports or the pogo pin female connector of the hub 33 to electrically connect to the pair of first signal pins 316, 317 of the processing unit 31 for allowing the communication information to send back to the processing unit 31. Moreover, the D+ pin 23 and the D− pin 24 of the original type-C USB 2 are able to be electrically connected to the pair of first signal pins 316, 317 of the processing unit 31 through the hub 33. As a result, the present invention is able to send the communication information from one of the type-C USB ports, the pogo pin female connector, or the original type-C USB port 2 back to the pair of first signal pins 316, 317 of the processing unit 31. In other words, the present invention allows the processing unit 31 to stay in the host mode for controlling the hub, while also allows the communication information from one of the type-C USB ports or/and the pogo pin female connector of the hub, or/and from the original type-C USB port 2 to send back to the processing unit 31. The present invention is thus able to solve the following problems mentioned for prior arts: (1) having insufficient numbers of type-C USB ports (or of any type of USB ports) available for use on an electronic device; and (2) having the processing unit unable to stay in host mode for controlling the hub, and thus having the processing unit unable to receive the communication information returning from the hub for the extension ports that are on the hub.

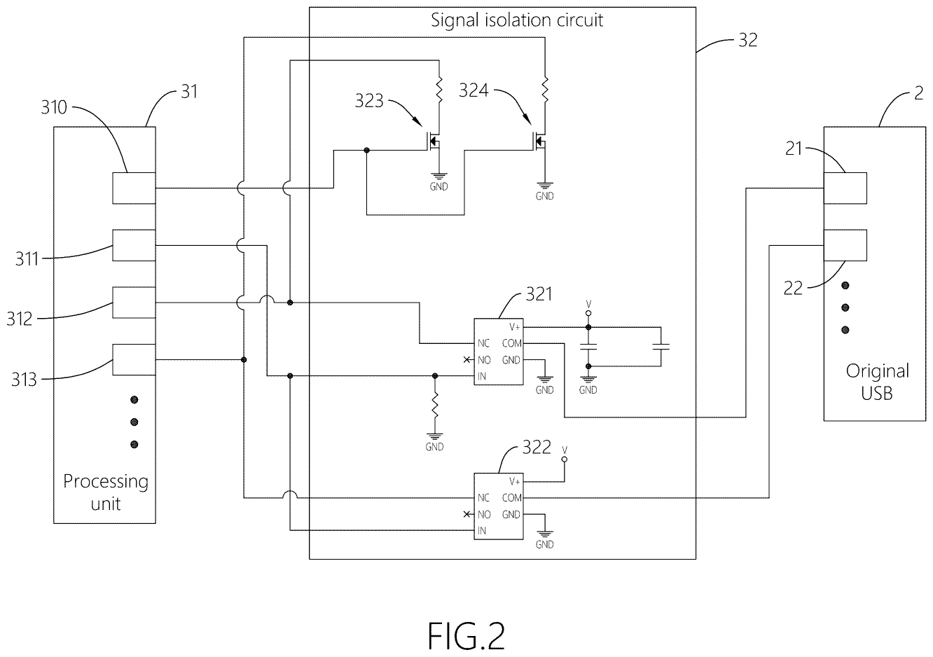

With reference to FIG. 2, in an embodiment of the present invention, the signal isolation circuit 32 further includes two switch integrated circuit (IC) chips 321, 322 and two N-type metal-oxide-semiconductor field-effect transistors (MOSFETs) 323, 324. More particularly, the two switch IC chips 321, 322 respectively include an IN pin, a NO pin, a NC pin, a COM pin, a V+ pin, and a GND pin. The N-type MOSFETs 323, 324 respectively include a gate, a drain, and a source.

For the switch IC chip 321, the NC pin of the switch IC chip 321 is electrically connected to the first USB mode detection pin 312 of the processing unit 31; the NO pin of the switch IC chip 321 is an open circuit; the IN pin of the switch IC chip 321 is electrically connected to the second enable pin 311 of the processing unit 31; the V+ pin of the switch IC chip 321 is electrically connected to a power voltage port V; the COM pin of the switch IC chip 321 is electrically connected to the CC1 pin 21 of the original type-C USB port 2; and the GND pin of the switch IC chip 321 is electrically connected to a ground port GND.

For the switch IC chip 322, the NC pin of the switch IC chip 322 is electrically connected to the second USB mode detection pin 313 of the processing unit 31; the NO pin of the switch IC chip 322 is an open circuit; the IN pin of the switch IC chip 322 is electrically connected to the second enable pin 311 of the processing unit 31; the V+pin of the switch IC chip 322 is electrically connected to the power voltage port V; the COM pin of the switch IC chip 322 is electrically connected to the CC2 pin 22 of the original type-C USB port 2; and the GND pin of the switch IC chip 322 is electrically connected to the ground port GND.

For the N-type MOSFET 323, the gate of the N-type MOSFET 323 is electrically connected to the first enable pin 310 of the processing unit 31; the source of the N-type MOSFET 323 is electrically connected to the ground port GND; and the drain of the N-type MOSFET 323 is electrically connected to the first USB mode detection pin 312 of the processing unit 31.

For the N-type MOSFET 324, the gate of the N-type MOSFET 324 is electrically connected to the first enable pin 310 of the processing unit 31; the source of the N-type MOSFET 324 is electrically connected to the ground port GND; and the drain of the N-type MOSFET 324 is electrically connected to the second USB mode detection pin 313 of the processing unit 31.

When the switch IC chips 321, 322 respectively receive the first voltage signal from the respective IN pins, and when the N-type MOSFETs 323, 324 respectively receive the first voltage signal from the respective gates, the switch IC chips 321, 322 respectively control the respective COM pins to electrically connect to the respective NC pins according to the first voltage signal, thus allowing the CC1 pin 21 and the CC2 pin 22 of the original type-C USB port 2 to electrically connect to the pair of USB mode detection pins 312, 313 of the processing unit 31. Simultaneously, the N-type MOSFETs 323, 324 respectively switch off according to the first voltage signal, thus, the gates of the respective N-type MOSFETs 323, 324 are switched off for disconnecting the respective sources and the respective drains. As a result, the switch IC chips 321, 322 allows the present invention to retain the original function of the original type-C USB port 2, because the pair of USB mode detection pins 312, 313 of the processing unit 31 are able to receive signals from the CC1 pin 21 and the CC2 pin 22 of the original type-C USB port 2 through the switch IC chips 321, 322. This allows the processing unit 31 to be configured in either the host mode or the device mode for collaborating with the original type-C USB port 2.

On the other hand, when the switch IC chips 321, 322 respectively receive the second voltage signal from the respective IN pins, and when the N-type MOSFETs 323, 324 respectively receive the second voltage signal from the respective gates, the switch IC chips 321, 322 respectively control the respective COM pins to electrically disconnect from the respective NC pins and to electrically connect to the respective NO pins according to the second voltage signal, thus allowing the CC1 pin 21 and the CC2 pin 22 of the original type-C USB port 2 to electrically disconnect from the pair of USB mode detection pins 312, 313 of the processing unit 31. Simultaneously, the N-type MOSFETs 323, 324 respectively switch on according to the second voltage signal, thus, the gates of the respective N-type MOSFETs 323, 324 are switched on for electrically connecting the respective sources and the respective drains. As a result, the switch IC chips 321, 322 allows the present invention to isolate signals coming from the CC1 pin 21 and the CC2 pin 22 of the original type-C USB port 2. At the same time, the N-type MOSFETs 323, 324 are able to generate and output the host mode signal to the pair of USB mode detection pins 312, 313 of the processing unit 31, thus notifying the processing unit 31 to keep staying in the host mode.

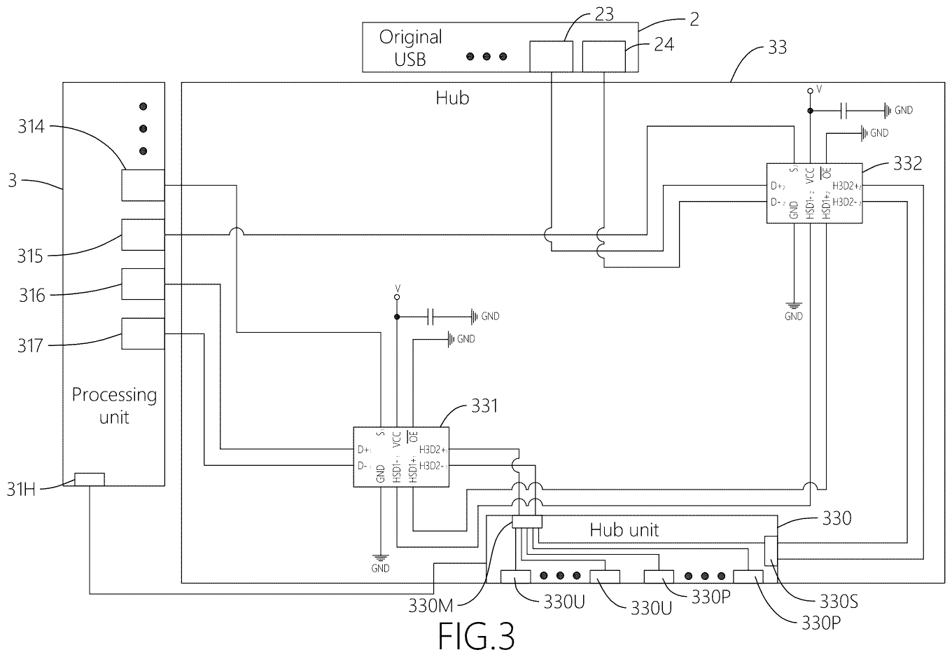

With reference to FIG. 3, the hub 33 further includes a hub unit 330, a first hub switch IC chip 331, and a second hub switch IC chip 332.

The hub unit 330 includes a plurality of type-C USB ports 330U, a plurality of pogo pin female connectors 330P, a bridge USB port 330S, and a main USB port 330M. The plurality of type-C USB ports 330U, the plurality of pogo pin female connectors 330P, and the bridge USB port 330S are mounted on the shell 1. The main USB port 330M is electrically connected to the plurality of type-C USB ports 330U, the plurality of pogo pin female connectors 330P, and the bridge USB port 330S. In an embodiment, the hub unit 330 is able to adjust its own electrical pathways according to its own usage. For example, according to how the hub unit 330 is configured to be used, one of the plurality of type-C USB ports 330U, the plurality of pogo pin female connectors 330P, or the bridge USB port 330S may be configured to electrically connected to the main USB port 330M for usage, while the others may be disabled from usage with adjusted open circuits. In general, the bridge USB port 330S has the function for bridging between the first hub switch IC chip 331 and the second bub switch IC chip 332.

The first hub switch IC chip 331 includes a first command receiver port S₁, a pair of first input ports D+₁, D−₁, a pair of first pathway output ports HSD1+₁, HSD1−₁, a pair of second pathway output ports H3D2+₁, H3D2−₁, a VCC port, and a GND port.

For the first hub switch IC chip 331, the first command receiver port S₁ of the first hub switch IC chip 331 is electrically connected to the first switch control pin 314 of the processing unit 31; the pair of first input ports D+₁, D−₁ of the first hub switch IC chip 331 are electrically connected to the pair of first signal pins 316, 317 of the processing unit 31; the pair of second pathway output ports H3D2+₁, H3D2−₁ of the first hub switch IC chip 331 are electrically connected to the main USB port 330M of the hub unit 330; the VCC port of the first hub switch IC chip 331 is electrically connected to the power voltage port V; and the GND port of the first hub switch IC chip 331 is electrically connected to the ground port GND.

The second hub switch IC chip 332 includes a second command receiver port S₂, a pair of first output ports D+₂, D−₂, a pair of first pathway input ports HSD1+₂, HSD1−₂, a pair of second pathway input ports H3D2+₂, H3D2−₂, a VCC port, and a GND port.

For the second hub switch IC chip 332, the second command receiver port S₂ of the second hub switch IC chip 332 is electrically connected to the second switch control pin 315 of the processing unit 31; the pair of first output ports D+₂, D−₂ of the second hub switch IC chip 332 are electrically connected to the D+ pin 23 and the D− pin 24 of the original type-C USB 2; the pair of first pathway input ports HSD1+₂, HSD1−₂ of the second hub switch IC chip 332 are electrically connected to the pair of first pathway output ports HSD1+₁, HSD1−₁ of the first hub switch IC chip 331; the pair of second pathway input ports H3D2+₂, H3D2−₂ of the second hub switch IC chip 332 are electrically connected to the bridge USB port 330S of the hub unit 330; the VCC port of the second hub switch IC chip 332 is electrically connected to the power voltage port V; and the GND port of the second hub switch IC chip 332 is electrically connected to the ground port GND.

When the first command receiver port S₁ of the first hub switch IC chip 331 and the second command receiver port S₂ of the second hub switch IC chip 332 respectively receive the third voltage signal from the first switch control pin 314 and the second switch control pin 315 of the processing unit 31, the first hub switch IC chip 331 controls the pair of first input ports D+₁, D−₁ of the first hub switch IC chip 331 to electrically connect the pair of first pathway output ports HSD1+₁, HSD1−₁ of the first hub switch IC chip 331 according to the respective third voltage signal, and the second hub switch IC chip 332 controls the pair of first output ports D+₂, D−₂ of the second hub switch IC chip 332 to electrically connect the pair of first pathway input ports HSD1+₂, HSD1−₂ of the second hub switch IC chip 332 according to the respective third voltage signal. As a result, the pair of first signal pins 316, 317 of the processing unit 31 are able to electrically connect the D+ pin 23 and the D− pin 24 of the original type-C USB 2 through the first hub switch IC chip 331 and the second hub switch IC chip 332. The D+ pin 23 and the D− pin 24 of the original type-C USB 2 can then follow the aforementioned electrical pathway to return information back to the processing unit 31.

On the other hand, when the first command receiver port S₁ of the first hub switch IC chip 331 and the second command receiver port S₂ of the second hub switch IC chip 332 respectively receive the fourth voltage signal from the first switch control pin 314 and the second switch control pin 315 of the processing unit 31, the first hub switch IC chip 331 controls the pair of first input ports D+₁, D−₁ of the first hub switch IC chip 331 to electrically connect the pair of second pathway output ports H3D2+₁, H3D2−₁ of the first hub switch IC chip 331 and to electrically disconnect from the pair of first pathway output ports HSD1+₁, HSD1−₁ of the first hub switch IC chip 331 according to the respective fourth voltage signal, thus, allowing the pair of first signal pins 316, 317 of the processing unit 31 to electrically connect the main USB port 330M of the hub unit 330 through the first hub switch IC chip 331. Simultaneously, the second hub switch IC chip 332 controls the pair of first output ports D+₂, D−₂ of the second hub switch IC chip 332 to electrically connect the pair of second pathway input ports H3D2+₂, H3D2−₂ of the second hub switch IC chip 332 and to electrically disconnect from the pair of first pathway input ports HSD1+₂, HSD1−₂ of the second hub switch IC chip 332 according to the respective fourth voltage signal, thus, allowing the bridge USB port 330S of the hub unit 330 to electrically connect the D+ pin 23 and the D− pin 24 of the original type-C USB 2 through the second hub switch IC chip 332. When the hub unit 330 controls the bridge USB port 330S to electrically connect the main USB port 330M, the processing unit 31 of the present invention would be able to stay in host mode to electrically connect the bridge USB port 330S and the original type-C USB 2 through the second hub switch IC chip 332. As a result, the hub unit 330 would then be able to return the communication information outputted by one of the plurality of type-C USB ports 330U, one of the plurality of pogo pin female connectors 330P, or the original type-C USB 2 to the pair of first signal pins 316, 317 of the processing unit 31 through the main USB port 330M of the hub unit 330.

Furthermore, the GPIO of the processing unit 31 includes a hub power pin 31H, and the hub power pin 31H is electrically connected to the hub unit 330 of the hub 33.

When the first enable pin 310 and the second enable pin 311 of the processing unit 31 respectively output the first voltage signal, and when the first switch control pin 314 and the second switch control pin 315 respectively output the third voltage signal, the processing unit 31 stops providing hub power to the hub unit 330. On the other hand, when the first enable pin 310 and the second enable pin 311 of the processing unit 31 respectively output the second voltage signal, and when the first switch control pin 314 and the second switch control pin 315 respectively output the fourth voltage signal, the processing unit 31 outputs the hub power from the hub power pin 31H of the GPIO to the hub unit 330 of the hub 33. In other words, the processing unit 31 only provides electricity to the hub unit 330 when the processing unit 31 is in host mode, and when the processing unit 31 switches to be in device mode, the processing unit 31 stops providing electricity to the hub unit 330, thus the processing unit 31 conserves electricity as much as possible depending on the aforementioned modes the processing unit 31 is in.

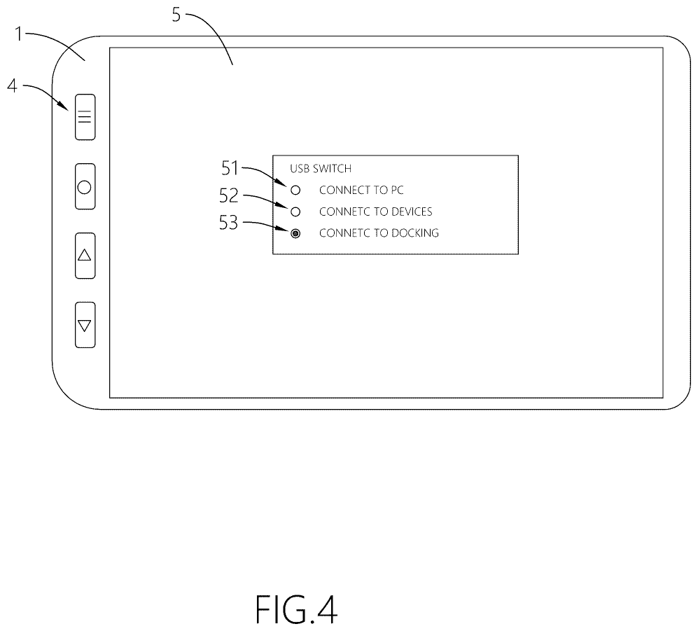

With references to FIG. 1 and FIG. 4, the electronic device of the present invention further includes an input module 4 and a display module 5. The input module 4 and the display module 5 are respectively electrically connected to the processing unit 31, and both the input module 4 and the display module 5 are mounted on the shell 1. In the present embodiment, the input module 4 includes a plurality of push buttons, and the display module 5 is a display. In other embodiments, the input module 4 and the display module 5 can be integrated into a touch screen.

In an embodiment, the processing unit 31 is a processor located inside of an electronic device, and the electronic device has a central processing unit (CPU). In other words, the processing unit 31 may be one of a plurality of processors within the electronic device. Moreover, the CPU is electrically connected to the input module 4, the display module 5, and the processing unit 31 of the present invention, thus the CPU is able to control an overall operation of the input module 4, the display module 5, and the port extension module 3.

The CPU also controls the display module 5 to display information. More particularly, under the CPU's overall control, the processing unit 31 may output a display signal to the display module 5, thus allowing the display module 5 to display a connect to computer option 51, a connect to device option 52, and a connect to docking station option 53 according to display signal for a user of the present invention. In an embodiment, the processing unit 31 sends the display signal to the CPU, and the display signal is delivered to the display module 5 through the CPU, thus allowing the display module 5 to display the connect to computer option 51, the connect to device option 52, and the connect to docking station option 53. The user may manipulate the input module 4 to select one of the connect to computer option 51, the connect to device option 52, and the connect to docking station option 53.

The connect to computer option 51 is a general mode option, as the connect to computer option 51 may be selected through the input module 4 for using a general mode for the user, and under the general mode, the original type-C USB port 2 retains its original functions for use. More particularly, when the input module 4 generates a general mode selection signal and sends the general mode selection signal to the processing unit 31, or when the input module 4 generates and sends the general mode selection signal to the CPU, and the CPU relays the general mode selection signal to the processing unit 31, upon receiving the general mode selection signal, the processing unit 31 selects the connect to computer option 51 according to the general mode selection signal and configures itself to be in the general mode. Simultaneously, the processing unit 31 outputs the first voltage signal from the first enable pin 310 and from the second enable pin 311 respectively to the signal isolation circuit 32, and the processing unit 31 also outputs the third voltage signal from the first switch control pin 314 and from the second switch control pin 315 respectively to the hub 33.

The connect to device option 52 and the connect to docking station option 53 are respectively an input extension mode option, as either the connect to device option 52 or the connect to docking station option 53 may be selected through the input module 4 for using an input extension mode for the user, and under the input extension mode, the hub unit 330 would be available for use, thus allowing the extension ports that are the type-C USB ports 330U and the pogo pin female connectors 330P available for use for the user. More particularly, when the input module 4 generates an input extension mode selection signal and sends the input extension mode selection signal to the processing unit 31, or when the input module 4 generates and sends the input extension mode selection signal to the CPU, and the CPU relays the input extension mode selection signal to the processing unit 31, upon receiving the input extension mode selection signal, the processing unit 31 configures itself to be in the input extension mode. Simultaneously, the processing unit 31 outputs the second voltage signal from the first enable pin 310 and from the second enable pin 311 respectively to the signal isolation circuit 32, and the processing unit 31 also outputs the fourth voltage signal from the first switch control pin 314 and from the second switch control pin 315 respectively to the hub 33. In the present embodiment, a voltage value of the second voltage signal is higher than a voltage value of the first voltage signal, and a voltage value of the fourth voltage signal is higher than a voltage value of the third voltage signal. The signal isolation circuit 32 is able to adjust its own aforementioned electrical pathways according to voltage value changes between the first voltage signal and the second voltage signal, and the hub 33 is able to adjust its own aforementioned electrical pathways according to voltage value changes between the third voltage signal and the fourth voltage signal.

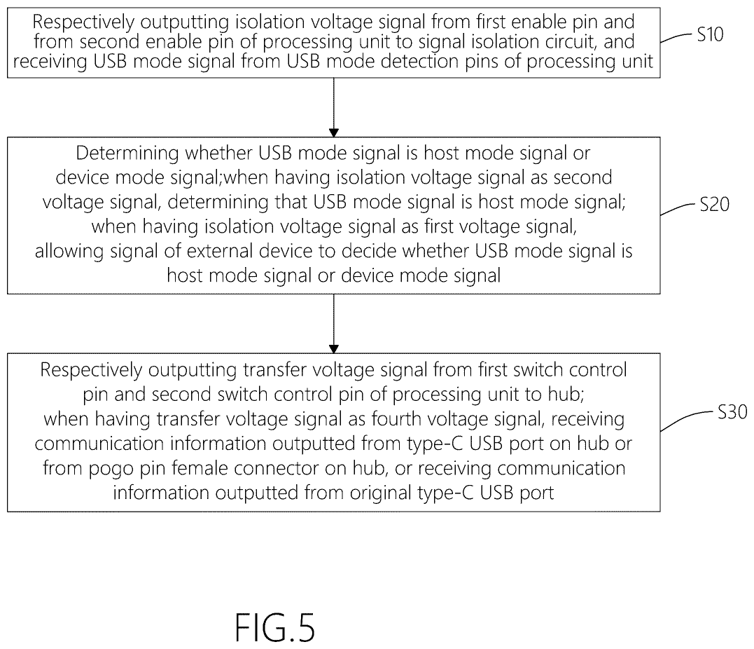

With reference to FIG. 5, a utilization method of extension port of the present invention is executed by the processing unit 31 of the aforementioned electronic device. With reference the aforementioned technical features, the utilization method is hereby concluded to include the following overall steps:
step S10: respectively outputting an isolation voltage signal from a first enable pin and from a second enable pin of the processing unit to a signal isolation circuit, and receiving a USB mode signal from a pair of USB mode detection pins of the processing unit;
step S20: determining whether the USB mode signal is a host mode signal or a device mode signal; wherein when having the isolation voltage signal as a second voltage signal, determining that the USB mode signal is the host mode signal; when having the isolation voltage signal as a first voltage signal, allowing a signal of an external device to decide whether the USB mode signal is the host mode signal or the device mode signal;
step S30: respectively outputting a transfer voltage signal from a first switch control pin and a second switch control pin of the processing unit to a hub; wherein when having the transfer voltage signal as a fourth voltage signal, receiving a communication information outputted from a type-C USB port on the hub or from a pogo pin female connector on the hub, or receiving a communication information outputted from an original type-C USB port.

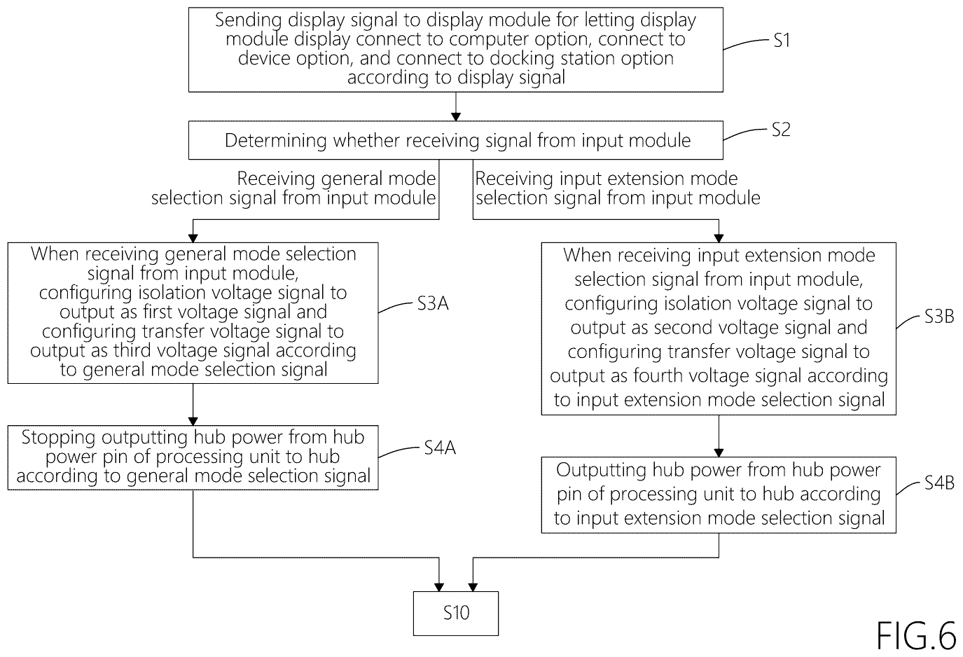

With reference to FIG. 6, in an embodiment, before executing step S10, the processing unit first executes the following steps:
step S1: sending a display signal to a display module for letting the display module display a connect to computer option, a connect to device option, and a connect to docking station option according to the display signal;
step S2: determining whether receiving a signal from an input module;
step S3A: when receiving a general mode selection signal from the input module, configuring the isolation voltage signal to output as the first voltage signal and configuring the transfer voltage signal to output as a third voltage signal according to the general mode selection signal;
step S4A: stopping outputting hub power from a hub power pin of the processing unit to the hub according to the general mode selection signal, and executing step S10;
step S3B: when receiving an input extension mode selection signal from the input module, configuring the isolation voltage signal to output as the second voltage signal and configuring the transfer voltage signal to output as the fourth voltage signal according to the input extension mode selection signal;
step S4B: outputting the hub power from the hub power pin of the processing unit to the hub according to the input extension mode selection signal, and executing step S10.

What is claimed is:

1. An electronic device having an extension port, comprising:
a shell;
an original type-C universal serial bus (USB) port, mounted on the shell, and comprising a positive data (D+) pin, a negative data (D−) pin, a first configuration channel (CC1) pin, and a second configuration channel (CC2) pin;
a port extension module, comprising:
a processing unit, comprising a general-purpose input/output (GPIO), wherein the GPIO comprises a first enable pin, a second enable pin, a first switch control pin, a second switch control pin, a pair of USB mode detection pins, and a pair of first signal pins;
a signal isolation circuit, electrically connected to the first enable pin, the second enable pin, and the pair of USB mode detection pins of the processing unit, and also electrically connected to the CC1 pin and the CC2 pin of the original type-C USB port; and
a hub, comprising a plurality of type-C USB ports and at least one pogo pin female connector, and electrically connected to the first switch control pin, the second switch control pin, and the first signal pins of the processing unit; wherein the type-C USB ports and at least one pogo pin female connector are mounted on the shell;
wherein when the signal isolation circuit respectively receives a first voltage signal from the first enable pin and from the second enable pin of the processing unit, and when the hub respectively receives a third voltage signal from the first switch control pin and from the second switch control pin of the processing unit, the signal isolation circuit controls the CC1 pin and the CC2 pin of the original type-C USB port to electrically connect the pair of USB mode detection pins of the processing unit according to the first voltage signal, and the hub controls the D+ pin and the D− pin of the original type-C USB port to electrically connect the pair of first signal pins of the processing unit according to the third voltage signal;
wherein when the signal isolation circuit respectively receives a second voltage signal from the first enable pin and from the second enable pin of the processing unit, and when the hub respectively receives a fourth voltage signal from the first switch control pin and from the second switch control pin of the processing unit, the signal isolation circuit controls the CC1 pin and the CC2 pin of the original type-C USB port to become open circuit according to the second voltage signal, the signal isolation circuit also generates a host mode signal and outputs the host mode signal to the pair of USB mode detection pins of the processing unit, and the hub controls one of the type-C USB ports or the pogo pin female connector to electrically connect the pair of first signal pins of the processing unit and the D+ pin and the D− pin of the original type-C USB port according to the fourth voltage signal.

2. The electronic device as claimed in claim 1, further comprising:
an input module, mounted on the shell, and electrically connected to the processing unit;
wherein when the input module generates and sends a general mode selection signal to the processing unit, the processing unit outputs the first voltage signal from the first enable pin and from the second enable pin respectively, and the processing unit also outputs the third voltage signal from the first switch control pin and from the second switch control pin respectively;
wherein when the input module generates and sends an input extension mode selection signal to the processing unit, the processing unit outputs the second voltage signal from the first enable pin and from the second enable pin respectively, and the processing unit also outputs the fourth voltage signal from the first switch control pin and from the second switch control pin respectively;
wherein a voltage value of the second voltage signal is higher than a voltage value of the first voltage signal, and a voltage value of the fourth voltage signal is higher than a voltage value of the third voltage signal.

3. The electronic device as claimed in claim 2, further comprising:
a display module, mounted on the shell, electrically connected to the processing unit, and displaying a general mode option and an input extension mode option;
wherein the general mode option corresponds to a selectable option for the input module to generate and send the general mode selection signal to the processing unit;
wherein the input extension mode option corresponds to a selectable option for the input module to generate and send the input extension mode selection signal to the processing unit.

4. The electronic device as claimed in claim 1, wherein the signal isolation circuit further comprises:
two switch integrated circuit (IC) chips; wherein each of the switch IC chips respectively comprises an IN pin, a NO pin, a NC pin, and a COM pin;
wherein the IN pins of the switch IC chips are electrically connected to the second enable pin of the processing unit, the NO pins of the switch IC chips are open circuits, the NC pins of the switch IC chips are electrically connected to the pair of USB mode detection pins, and the COM pins of the switch IC chips are electrically connected to the CC1 pin and the CC2 pin of the original type-C USB port; and
two N-type metal-oxide-semiconductor field-effect transistors (MOSFETs); wherein each of the N-type MOSFETs respectively comprises a gate, a drain, and a source; wherein the sources of the N-type MOSFETs are electrically connected to a ground, the gates of the N-type MOSFETs are electrically connected to the first enable pin of the processing unit, and the drains of the N-type MOSFETs are electrically connected to the pair of USB mode detection pins of the processing unit;
wherein when the switch IC chips respectively receive the first voltage signal on the IN pins, and when the N-type MOSFETs respectively receive the first voltage signal on the gates, the switch IC chips respectively control the respective COM pin to electrically connect to the respective NC pin according to the respective first voltage signal, thus allowing the CC1 pin and the CC2 pin of the original type-C USB port to electrically connect the pair of USB mode detection pins of the processing unit, and simultaneously, the N-type MOSFETs respectively switch off according to the first voltage signal;
wherein when the switch IC chips respectively receive the second voltage signal on the IN pins, and when the N-type MOSFETs respectively receive the second voltage signal on the gates, the switch IC chips respectively control the respective COM pin to electrically disconnect from the respective NC pin and to electrically connect to the respective NO pin according to the respective second voltage signal, thus allowing the CC1 pin and the CC2 pin of the original type-C USB port to stop electrically connecting the pair of USB mode detection pins of the processing unit, and simultaneously, the N-type MOSFETs respectively switch on according to the second voltage signal, thus outputting the host mode signal to the pair of USB mode detection pins of the processing unit.

5. The electronic device as claimed in claim 1, wherein the hub further comprises:
a first hub switch integrated circuit (IC) chip, comprising a first command receiver port, a first input port, a first pathway output port, and a second pathway output port; wherein the first command receiver port is electrically connected to the first switch control pin of the processing unit; and the first input port is electrically connected to the pair of first signal pins of the processing unit;
a second hub switch IC chip, comprising a second command receiver port, a first output port, a first pathway input port, and a second pathway input port; wherein the second command receiver port is electrically connected to the second switch control pin of the processing unit; the first output port is electrically connected to the D+ pin and the D− pin of the original type-C USB port; and the first pathway input port is electrically connected to the first pathway output port of the first hub switch IC chip; and
a hub unit, comprising a main USB port, a bridge USB port, the plurality of type-C USB ports, and the at least one pogo pin female connector; wherein the main USB port is electrically connected to the bridge USB port, the plurality of type-C USB ports, and the at least one pogo pin female connector; wherein the main USB port is electrically connected to the second pathway output port of the first hub switch IC chip, and the bridge USB port is further electrically connected to the second pathway input port of the second hub switch IC chip;
wherein when the first command receiver port of the first hub switch IC chip and the second command receiver port of the second hub switch IC chip respectively receive the respective fourth voltage signal from the first switch control pin and from the second switch control pin of the processing unit, the first hub switch IC chip controls the first input port to electrically disconnect from the first pathway output port and to electrically connect to the second pathway output port according to the respective fourth voltage signal, thus allowing the pair of first signal pins of the processing unit to electrically connect to the main USB port of the hub unit, and simultaneously, the second hub switch IC chip controls the first output port to electrically disconnect from the first pathway input port and to electrically connect to the second pathway input port according to the respective fourth voltage signal, thus allowing the bridge USB port to electrically connect the D+ pin and the D− pin of the original type-C USB port through the second hub switch IC chip.

6. The electronic device as claimed in claim 1, wherein the GPIO of the processing unit further comprises a hub power pin, and the hub power pin is electrically connected to the hub;
wherein when the first enable pin and the second enable pin of the processing unit respectively output the first voltage signal, and when the first switch control pin and the second switch control pin of the processing unit respectively output the third voltage signal, the processing unit stops outputting hub power to the hub;
wherein when the first enable pin and the second enable pin of the processing unit respectively output the second voltage signal, and when the first switch control pin and the second switch control pin of the processing unit respectively output the fourth voltage signal, the processing unit outputs the hub power to the hub.

7. A utilization method of an extension port, executed by a processing unit of the electronic device as claimed in claim 1, and comprising the following steps:
respectively outputting an isolation voltage signal from a first enable pin and from a second enable pin of the processing unit to a signal isolation circuit, and receiving a USB mode signal from a pair of USB mode detection pins of the processing unit; wherein when the isolation voltage signal is a second voltage signal, the USB mode signal is a host mode signal;
respectively outputting a transfer voltage signal from a first switch control pin and from a second switch control pin of the processing unit to a hub; wherein when the transfer voltage signal is a fourth voltage signal, the processing unit receives a communication information outputted from a type-C USB port on the hub or from a pogo pin female connector on the hub.

8. The utilization method as claimed in claim 7, wherein when the processing unit receives a general mode selection signal from an input module, the processing unit configures the isolation voltage signal as a first voltage signal according to the general mode selection signal, and the processing unit also configures the transfer voltage signal as a third voltage signal according to the general mode selection signal;
wherein when the processing unit receives an input extension mode selection signal from the input module, the processing unit configures the isolation voltage signal as the second voltage signal according to the input extension mode selection signal, and the processing unit also configures the transfer voltage signal as the fourth voltage signal according to the input extension mode selection signal.

9. The utilization method as claimed in claim 8, wherein the processing unit sends a display signal to a display module for letting the display module display a connect to computer option, a connect to device option, and a connect to docking station option according to the display signal; wherein the display module and the input module are a touch screen;
wherein when the connect to computer option is selected on the touch screen, the processing unit thus receives the general mode selection signal from the input module;
wherein when the connect to device option or the connect to docking station option is selected on the touch screen, the processing unit thus receives the input extension mode selection signal from the input module.

10. The utilization method as claimed in claim 8, wherein when the processing unit receives the input extension mode selection signal from the input module, the processing unit outputs hub power to the hub from a hub power pin according to the input extension mode selection signal;
wherein when the processing unit receives the general mode selection signal from the input module, the processing unit stops outputting the hub power to the hub from the hub power pin according to the general mode selection signal.
